(19) United States
(12) Patent Application Publication
(10) Pub. No.: US 2012/0266921 A1
(43) Pub. Date: Oct. 25, 2012

(54) THIN PLATE MEMBER WASHING APPARATUS

(75) Inventors: Toshiro FURUSAWA, Kyotanabe-shi (JP); Takanobu YAMAUCHI, Kyoto-shi (JP); Kentaro MORI, Nara-shi (JP); Masayuki ESAKI, Ibaraki-shi (JP); Masao MAEDA, Kyoto-shi (JP)

(73) Assignee: OMRON HEALTHCARE CO., LTD., Muko-shi (JP)

(21) Appl. No.: 13/540,076

(22) Filed: Jul. 2, 2012

Related U.S. Application Data
(63) Continuation of application No. PCT/JP2010/073838, filed on Dec. 29, 2010.

(30) Foreign Application Priority Data
Jan. 8, 2010 (JP) 2010-003038

(51) Int. Cl. B08B 3/04

(52) U.S. Cl. 134/117

(57) ABSTRACT

A thin plate member washing apparatus includes a washing vessel including a lid member and an elongated cylindrical vessel having at one end an opening that is closed by the lid member and in which tap water is contained, and a thin plate member fixing member that is housed in the washing vessel and holds a mesh member whose surface is washed with the tap water by moving within the washing vessel.

### TECHNICAL FIELD

The present invention relates to a thin plate member washing apparatus for washing a thin plate member.

### BACKGROUND ART

There is technology of vibrating a mesh member composed of a thin plate member made of metal or other materials in which multiple minute holes are formed and spraying fine particles of liquid. As a specific example, such technology is applied to atomizers (nebulizers or inhalers) used to administer drugs for asthma and the like by inhalation. It is desired that the mesh member is kept clean, especially in the case of nebulizers, because nebulizers are used for inhalation of medicinal fluid. Moreover, for example, in the case where a viscous medicinal fluid is used, washing after use is required so as to prevent clogging of the minute holes with the medicinal fluid sticking to the mesh member.

Typical examples of the method of washing the mesh member include: (a) a method of washing the mesh member by filling a medicinal fluid bottle of a nebulizer with tap water and spraying the tap water for a few minutes (washing by spraying water) and (b) a method of washing the mesh member by directly exposing a mesh portion to flowing tap water (washing with flowing water).

However, the method (a) of washing by spraying water consumes the battery of the nebulizer, resulting in a decrease in the time period before battery replacement is required. Care needs to be taken because it is undesirable for a user or other person to inhale the atomized water. Moreover, washing takes a lot of time and labor.

In the case of the method (b) of washing with flowing water, when washing is performed by directly exposing the mesh portion to flowing tap water, the mesh member may be damaged and deformed as a result of exposure to a strong stream of flowing water, because the mesh member often is a thin plate so that micromachining can be performed and clogging can be prevented. There also is a risk that the force of the water may cause the mesh member to be dropped from the hand and the mesh member may be washed down the drain.

The background art of the thin plate member washing apparatus for washing a mesh member or the like according to the present invention has been described based on common technical information in the art that has become known to the applicant of the present invention, but as far as the applicant remembers, the applicant does not have any information that should be disclosed as prior art literature information before the filing of the present application. Note that a technology of washing rice or cereals using the force of flowing tap water is disclosed in JP 2001-178639A, “Water Flow Type Rice Washer and Cereal Washer” (Patent Literature 1), although this technology belongs to a technical field different from the thin plate member washing apparatus. Also, a technology of washing the surface of a denture using air bubbles that form as a result of foaming of a washing agent is disclosed in JP 3007442U (Patent Literature 2).

### CITATION LIST

### Patent Literature

Patent Literature 1: JP 2001-178639A

Patent Literature 2: JP 3007442U

### SUMMARY OF INVENTION

### Technical Problem

Problems to be solved by the present invention are attributed to the non-existence of an apparatus for washing a thin plate member. Therefore, an object of the present invention is to provide a thin plate member washing apparatus that can efficiently wash a thin plate member without causing damage to the thin plate member.

### Solution to Problem

A thin plate member washing apparatus according to the present invention includes a washing vessel including a lid member and a cylindrical vessel having at one end an opening that is closed by the lid member and in which a liquid is contained, and a thin plate member fixing member that is housed in the washing vessel and holds a thin plate member whose surface is washed with the liquid by moving within the washing vessel, wherein the thin plate member fixing member has a first base member having a plurality of first openings that allow the liquid to pass through and a thin plate member holding portion that is fixed to the first base member and holds the thin plate member, and when the washing vessel is shaken in an axial direction of the washing vessel in a state in which the liquid is contained and the thin plate member fixing member is housed in the washing vessel, the thin plate member fixing member reciprocates within the washing vessel.

In another form of the thin plate member washing apparatus, the thin plate member fixing member has a second base member having a plurality of second openings that allow the liquid to pass through, in a position opposing the first base member with the thin plate member holding portion interposed therebetween. Preferably, the opening area of the first openings provided in the first base member is larger than the opening area of the second openings provided in the second base member.

In another form of any of the above-described thin plate member washing apparatuses, the thin plate member fixing member has a shock absorbing member that reduces the shock of a collision with an inner surface of the cylindrical vessel.

### Advantageous Effects of Invention

With the thin plate member washing apparatus according to the present invention, it is possible to provide a thin plate member washing apparatus that can efficiently wash a thin plate member without causing damage to the thin plate member.

### BRIEF DESCRIPTION OF DRAWINGS

FIG. 1 is a first perspective view showing an overall configuration of a nebulizer including a mesh member.

FIG. 2 is a second perspective view showing the overall configuration of the nebulizer including the mesh member.

FIGS. 3(A) and 3(B) are partial cross-sectional views as viewed from arrows III-III in FIG. 2.

FIG. 4 is an external view showing the configuration of a thin plate member washing apparatus of Embodiment 1.

FIG. 5 is a conceptual diagram illustrating the configuration of a thin plate member fixing member that is employed in the thin plate member washing apparatus of Embodiment 1.

FIG. 6 is a perspective view showing a specific configuration of the thin plate member fixing member that is employed in the thin plate member washing apparatus of Embodiment 1.

FIG. 7 is a perspective view showing the configuration of a thin plate member fixing member that is employed in a thin plate member washing apparatus of Embodiment 2.

FIG. 8 is a perspective view showing the configuration of a thin plate member fixing member that is employed in a thin plate member washing apparatus of Embodiment 3.

FIG. 9 is a diagram showing the configuration of a thin plate member fixing member that is employed in a thin plate member washing apparatus of Embodiment 4.

FIG. 10 is a diagram showing the configuration of a thin plate member fixing member that is employed in a thin plate member washing apparatus of Embodiment 5.

FIG. 11 is a diagram showing the configuration of a thin plate member fixing member that is employed in a thin plate member washing apparatus of Embodiment 6.

FIG. 12 is a diagram showing the configuration of a thin plate member fixing member that is employed in a thin plate member washing apparatus of Embodiment 7.

### DESCRIPTION OF EMBODIMENTS

Hereinafter, thin plate member washing apparatuses of embodiments according to the present invention will be described in detail with reference to the drawings. Note that in the case where a number, amount, or the like is mentioned in an embodiment described below, it is to be understood that the scope of the present invention is not necessarily limited to such a number, amount, or the like, unless otherwise stated. Moreover, in the case where a plurality of embodiments are described below, it is to be understood that it is planned to appropriately combine the individual embodiments, unless otherwise stated. The same reference numerals in the drawings indicate the same or corresponding portions, and redundant descriptions thereof may be omitted.

Moreover, although the case where tap water is used will be explained in descriptions of thin plate member washing apparatuses of embodiments below, a dedicated washing liquid can also be used.

### Nebulizer Including Mesh Member

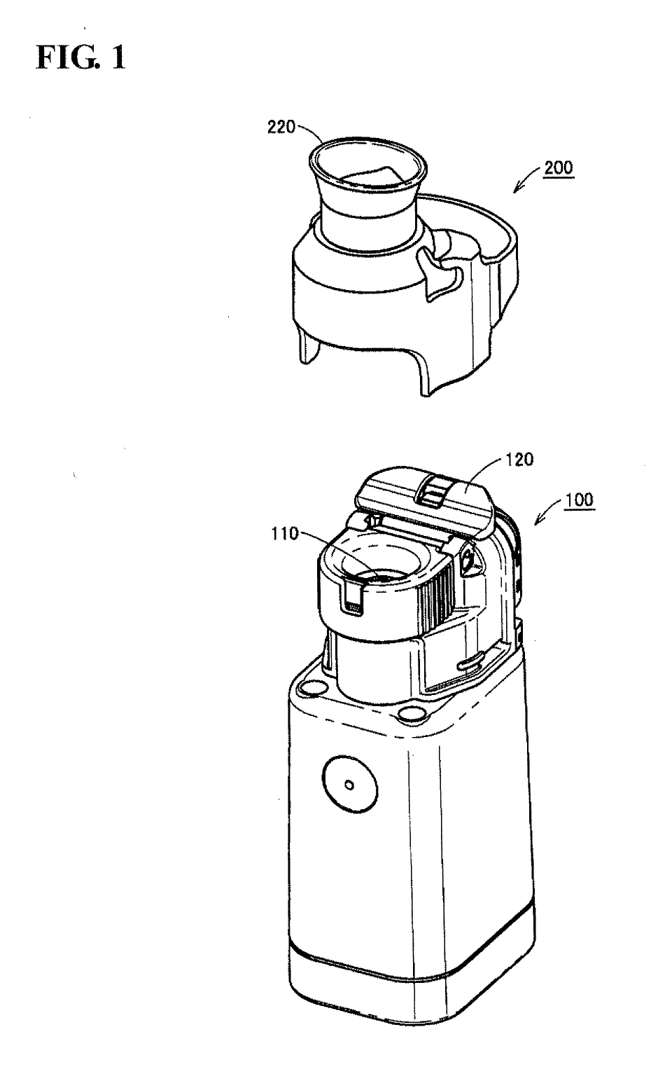

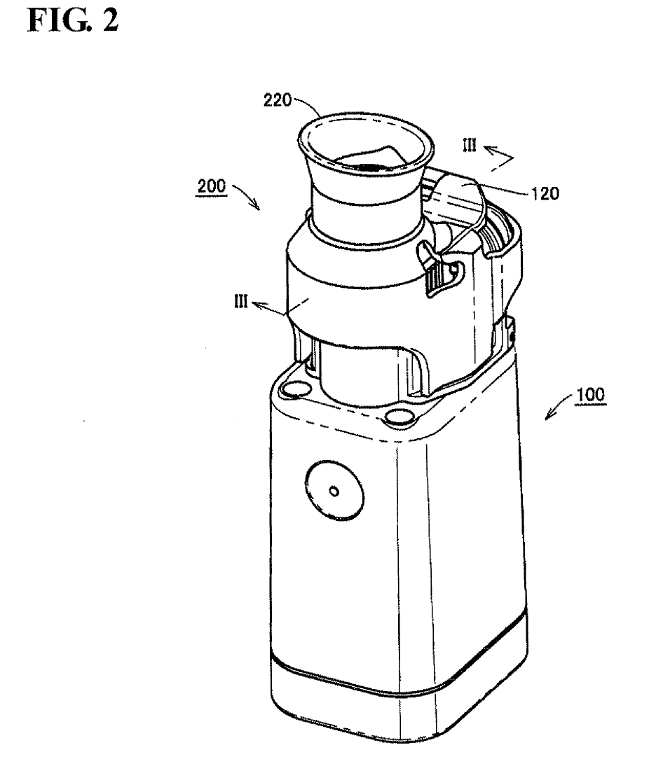

A nebulizer including a mesh member serving as an example of a member to be washed will be described first with reference to FIGS. 1 to 3. Nebulizers are devices that are used mainly for medical purposes. An atomization portion of a nebulizer atomizes a medicinal fluid into a mist of particles, and the user inhales the mist of the medicinal fluid through his/her mouth or nose for treatment of a disease in the bronchus, nasal cavity, throat, or the like.

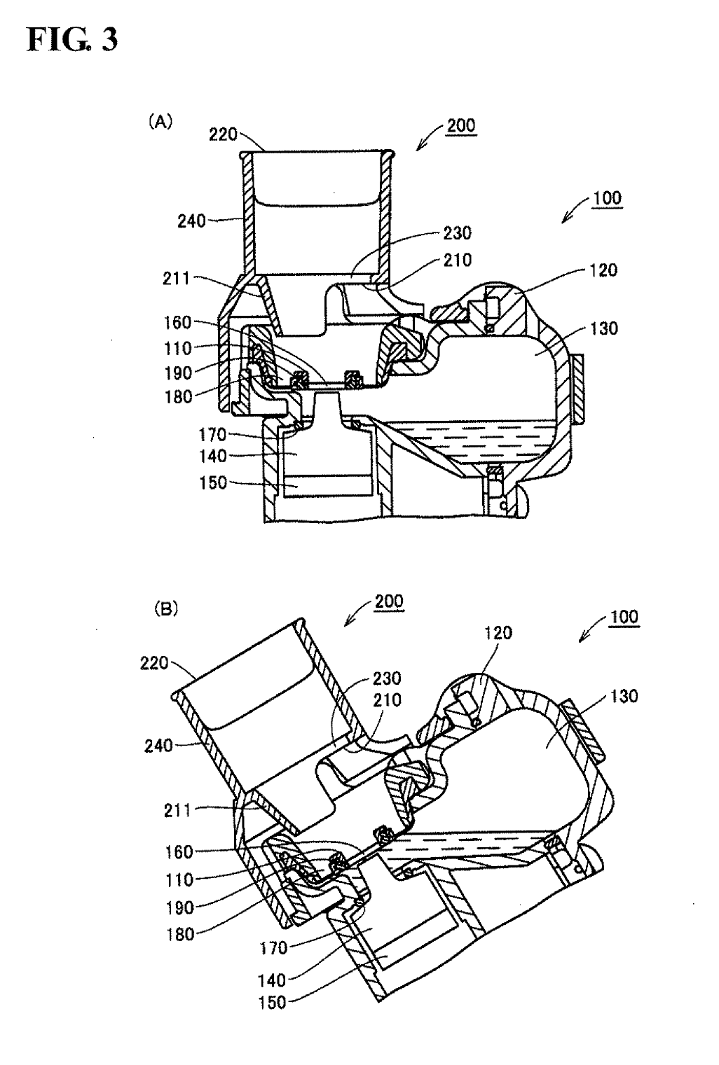

A nebulizer 100 shown in the drawings includes an ultrasonic mesh atomization mechanism. The nebulizer 100 includes a nozzle 110 for spraying the medicinal fluid on top of the atomization mechanism. Moreover, an open/close operation portion 120 for supplying the medicinal fluid into a medicinal fluid storage portion 130 (see FIG. 3) within the nebulizer 100 and facilitating washing of the medicinal fluid storage portion 130 is provided in an upper portion of the nebulizer 100. The medicinal fluid can also be supplied by opening and closing the nozzle 110.

A mouthpiece 200 serving as an inhalation aid for the nebulizer 100 is integrally formed from a resin material. The mouthpiece 200 has a shape that enables attachment to the top of the nebulizer 100, and includes a tubular portion 240 (see FIG. 3) inside, through which the mist of the medicinal fluid sprayed from the nozzle 110 of the nebulizer 100 passes.

An inhalation port 220 serving as a second opening to be held in the user's mouth is provided in an upper surface of the mouthpiece 200. The tubular portion 240 of the mouthpiece 200 has an air intake 230 serving as a third opening for taking in air at a predetermined position, rather than being attached to the nozzle 110 of the nebulizer 100 in an airtight manner.

The user uses the nebulizer 100 held in his/her hand in a state in which the mouthpiece 200 is attached to the top of the nebulizer 100. At this time, the user slightly tilts the nebulizer 100 toward him/her and holds the inhalation port 220 of the mouthpiece 200 in his/her mouth.

Next, the structure of the nebulizer 100 and the shape of the mouthpiece 200 will be described in further detail with reference to FIGS. 3(A) and 3(B). FIG. 3(A) shows a state in which the nebulizer 100 is kept in a horizontal position, and FIG. 3(B) shows a state in which the user has tilted the nebulizer 100 toward him/her to use the nebulizer 100.

The nebulizer 100 includes the ultrasonic mesh atomization mechanism immediately under the nozzle 110. The ultrasonic mesh atomization mechanism is composed of a piezoelectric element 150, a stepped horn 140, and a mesh member 160. The mesh member 160 has a metal thin plate member in which multiple minute holes are formed and a resin member provided around the thin plate member. A lower surface of the mesh member 160 is in contact with an end of the stepped horn 140. The mesh member 160 is detachably attached to a partition plate 190 so as to enable the user to detach it for washing.

The piezoelectric element 150 starts vibrating when driven by a power supply. The vibration propagates to the stepped horn 140, causing the medicinal fluid to be atomized at a contact surface between the stepped horn 140 and the mesh member 160. The atomized medicinal fluid is ejected from the minute holes toward the nozzle 110 of the nebulizer 100 with great force.

A fluid collecting portion 180 for storing the medicinal fluid that has been deposited on the tubular portion 240 and hence become liquid droplets and saliva that runs from the user's mouth is formed along a peripheral edge of the nozzle 110. The medicinal fluid and the saliva stored in the fluid collecting portion 180 are isolated by the partition plate 190 so as not to enter the mesh member 160 located on the inside of the fluid collecting portion 180. The mesh member 160 is detachably attached to the partition plate 190 so as to enable the user to detach it for washing.

The medicinal fluid storage portion 130 adjoining to the atomization portion is formed inside the nebulizer 100. The medicinal fluid is replenished by opening and closing the aforementioned nozzle 110. As a result of the nebulizer 100 being tilted during use, all of the medicinal fluid stored in the medicinal fluid storage portion 130 is supplied to the atomization portion and atomized. For this reason, the atomization portion has a watertight structure with an O-ring 170 in order to prevent the medicinal fluid from dripping into the apparatus.

As described above, the mouthpiece 200 includes the tubular portion 240 through which the atomized medicinal fluid passes and includes, at opposite ends of the tubular portion 240, an atomizer-side opening 210 serving as a first opening that faces the nozzle 110 of the nebulizer 100 in a state in which the mouthpiece 200 is attached to the nebulizer 100 and the inhalation port 220 serving as the second opening to be held in the user's mouth.

A flange portion 211 extending from a portion of the peripheral edge of the atomizer-side opening 210 and contiguous with the tubular portion 240 is provided. The flange portion 211 has a function of collecting and guiding the medicinal fluid that has become liquid droplets and the saliva into the fluid collecting portion 180 of the nebulizer 100 so as to prevent dripping of such liquid.

The flange portion 211 is not provided along the entire peripheral edge of the opening lest the tubular portion 240 is made airtight, but rather the air intake 230 for taking in air is formed in a portion of the peripheral edge of the atomizer-side opening where the flange portion is not formed. The air intake 230 is formed by cutting the atomizer-side opening. Thus, airflow is constantly generated in the tubular portion 240.

### Embodiment 1

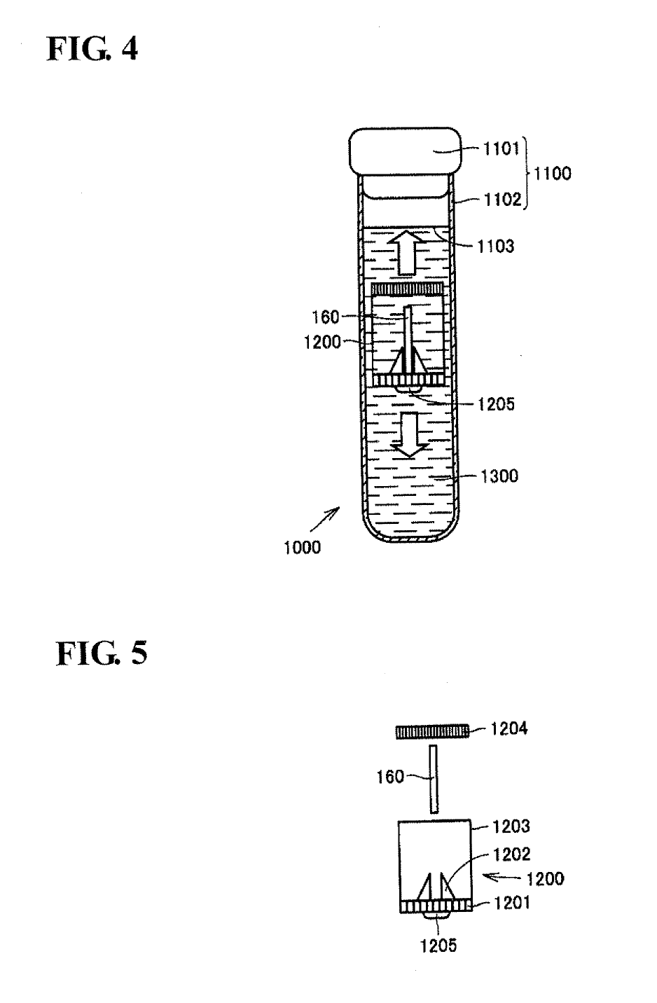

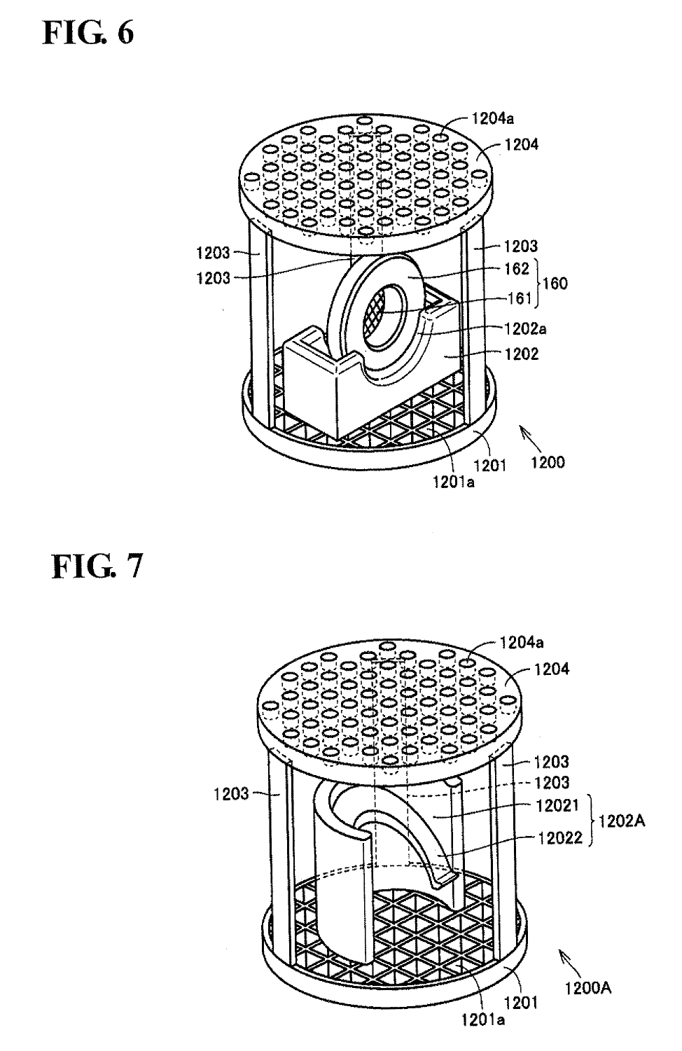

Next, the structure of a thin plate member washing apparatus 1000 of Embodiment 1 according to the present invention will be described with reference to FIGS. 4 to 6. FIG. 4 is an external view showing the configuration of the thin plate member washing apparatus 1000, FIG. 5 is a conceptual diagram illustrating the configuration of a thin plate member fixing member 1200 that is employed in the thin plate member washing apparatus 1000, and FIG. 6 is a perspective view showing a specific configuration of the thin plate member fixing member 1200.

### Thin Plate Member Washing Apparatus 1000

The thin plate member washing apparatus 1000 includes a washing vessel 1100 including a lid member 1101 and an elongated cylindrical vessel 1102 having at one end an opening that is closed by the lid member 1101 and in which tap water 1300 is contained, and a thin plate member fixing member 1200 that is housed in the washing vessel 1100 and holds a mesh member 160 whose surface is washed with the tap water 1300 by moving within the washing vessel 1100.

The cylindrical vessel 1102 has a vertically long cylindrical shape and is composed of a transparent member so that the interior of the vessel can be visually observed. For example, a resin material or a glass material can be used. A liquid surface line 1103 is engraved or printed on a side wall portion in an upper end region of the cylindrical vessel 1102 as a mark indicating a level to which tap water needs to be contained in the cylindrical vessel 1102. An elastically deformable member such as rubber is used for the lid member 1101, and allows the lid member 1101 to be waterproof and reduces the shock of a collision with a second base member 1204 (or the thin plate member fixing member 1200). Note that it is also possible to dispose the lid member 1101 such that it can open and close with respect to the cylindrical vessel 1102 by providing a screw between an upper end portion of the cylindrical vessel 1102 and the lid member 1101 and screwing them to each other.

The thin plate member fixing member 1200 has a first base member 1201, a mesh member holding portion 1202 that is fixed to the first base member 1201 and holds the mesh member 160, a second base member 1204 that is disposed in a position opposing the first base member 1201 with the mesh member holding portion 1202 interposed therebetween, and a plurality of support columns 1203 that join the first base member 1201 and the second base member 1204 to each other. The distance between the first base member 1201 and the second base member 1204 is set to a dimension that enables the user to insert and remove the mesh member 160 and that allows the mesh member 160 to shake during washing but prevents the mesh member 160 from jumping out of the thin plate member fixing member 1200.

In a state in which a defined amount of tap water 1300 is contained and the thin plate member fixing member 1200 is housed in the washing vessel 1100, the washing vessel 1100 is shaken in an axial direction of the washing vessel 1100 (moved up and down), and thus the thin plate member fixing member 1200 reciprocates within the washing vessel 1100.

As shown in detail in FIG. 6, the first base member 1201 is a plate having a circular shape smaller than the inner diameter of the cylindrical vessel 1102. Moreover, a plurality of first openings 1201a that allow the tap water 1300 to pass through are provided in the first base member 1201. In the present embodiment, the opening shape of the first openings 1201a is a quadrangular prism shape, but the opening shape is not limited to this shape, and a cylindrical shape, a conical shape, and other shapes can be employed.

The second base member 1204 is a plate having a circular shape smaller than the inner diameter of the cylindrical vessel 1102 as is the case with the first base member 1201. A plurality of second openings 1204a that allow the tap water 1300 to pass through are provided in the second base member 1204 as well. In the present embodiment, the opening shape of the second openings 1204a is a cylindrical shape, but the opening shape is not limited to this shape, and a quadrangular prism shape, a conical shape, and other shapes can be employed.

The first base member 1201 and the second base member 1204 are mutually fixed by the three support columns 1203 such that the two members are disposed opposing each other. The shape and number of the support columns 1203 are not limited to those mentioned in the present embodiment. Moreover, the support columns 1203 may be detachable from the first base member 1201 and the second base member 1204.

In the present embodiment, the opening area of the first openings 1201a provided in the first base member 1201 is set to be larger than the opening area of the second openings 1204a provided in the second base member 1204.

Thus, in the case where the thin plate member fixing member 1200 reciprocates within the washing vessel 1100, a difference in flow arises between the tap water 1300 passing through the first base member 1201 and the tap water 1300 passing through second base member 1204, and a turbulent flow can be produced between the first base member 1201 and the second base member 1204. As a result, the efficiency of cleaning the mesh member 160 can be enhanced even more. Moreover, the tap water 1300, as a result of passing through the first openings 1201a and the second openings 1204a, takes in air within the cylindrical vessel 1102, and bubbles containing air bubbles form. It can be expected that an impact of the air bubbles contained in the bubbles on the mesh member 160 and the energy released when the air bubbles burst enhances the washing effect.

Note that even in the case where the opening area of the first openings 1201a provided in the first base member 1201 and the opening area of the second openings 1204a provided in the second base member 1204 are set to be equal, a sufficient washing effect can be obtained because the tap water 1300 flows over the surface of the mesh member 160.

The mesh member holding portion 1202 for holding the mesh member 160 in a state in which it is in an upright position is provided on the first base member 1201. The state in which the mesh member 160 is in an upright position refers to a case where a plane containing the mesh member 160 is parallel to a longitudinal axis direction of the washing vessel 1100. The mesh member 160 is composed of a metal thin plate member 161 in which a plurality of minute holes are formed and an annular resin member 162 integrally provided around the thin plate member 161.

The mesh member holding portion 1202 has a semicircular groove portion 1202a that holds the mesh member 160 from the lower lateral side in a state in which the mesh member 160 is in an upright position. The groove portion 1202a is formed to have a larger width than the mesh member 160, so that the mesh member 160 can shake within the mesh member holding portion 1202, and the washing effect can be enhanced even more.

### Washing of Mesh Member 160

When the mesh member 160 is washed using the thin plate member washing apparatus 1000, as shown in FIG. 4, a defined amount of tap water 1300 is contained and the thin plate member fixing member 1200 is housed in the washing vessel 1100, and in this state, the washing vessel 1100 is shaken in the axial direction of the washing vessel 1100 (moved up and down) and thus the thin plate member fixing member 1200 reciprocates within the washing vessel 1100. This causes the tap water 1300 to flow over the surface of the mesh member 160, and medicinal fluid residue and the like deposited on the mesh member 160 are removed.

### Effects

As described above, with the thin plate member washing apparatus 1000 of the present embodiment, the mesh member 160 is washed by shaking the thin plate member washing apparatus 1000 in which the thin plate member fixing member 1200 and the tap water 1300 are housed, and therefore the mesh member 160 can be easily washed. Moreover, quantitative and more uniform washing can be achieved by predetermining the number of times the thin plate member washing apparatus 1000 is shaken.

Moreover, since the washing vessel 1100 is vertically long, the user can intuitively recognize the direction in which the user needs to shake the apparatus, and therefore washing can be performed in a fixed direction and unevenness of washing due to the user can also be suppressed.

Moreover, when the thin plate member washing apparatus 1000 is shaken, air that is present in the thin plate member washing apparatus 1000 is taken in the tap water 1300, so that air bubbles can form. Thus, the mesh member 160 washing effect can also be enhanced by minute vibrations due to collisions and bursting of the air bubbles.

Moreover, water with great force does not strike the mesh member 160 and therefore cannot damage the mesh member 160, especially the metal thin plate member 161. Moreover, the mesh member 160 is accommodated inside the thin plate member washing apparatus 1000 and therefore cannot be lost.

Moreover, the thin plate member washing apparatus 1000 has such a size that it can be always carried, and therefore can be carried together with the above-described nebulizer.

As described above, with the thin plate member washing apparatus 1000 of the present embodiment, it is possible to efficiently wash a mesh member 160 without causing damage to the mesh member 160.

### Embodiment 2

Next, the structure of a thin plate member washing apparatus of Embodiment 2 according to the present invention will be described with reference to FIG. 7. The thin plate member washing apparatus of Embodiment 2 has the same basic configuration as the above-described thin plate member washing apparatus 1000 of Embodiment 1. The difference is only the form of a mesh member holding portion 1202A of a thin plate member fixing member 1200A.

Therefore, in the drawings, the same components are denoted by the same reference numerals and duplication is eliminated, and only the mesh member holding portion 1202A of the thin plate member fixing member 1200A of the present embodiment will be described. FIG. 7 is a perspective view showing a specific configuration of the thin plate member fixing member 1200A.

### Thin Plate Member Fixing Member 1200A/Mesh Member Holding Portion 1202A

As shown in FIG. 7, the thin plate member fixing member 1200A of this embodiment is provided with the mesh member holding portion 1202A for holding the mesh member 160 in a state in which it is in a sloping position on an upper surface side of the first base member 1201 The state in which the mesh member 160 is in a sloping position refers to a case where the plane containing the mesh member 160 intersects the longitudinal axis direction of the washing vessel 1100. In Embodiment 1, the plane containing the mesh member 160 is parallel to the longitudinal axis direction of the washing vessel 1100 and in Embodiment 3, which will be described later, the plane containing the mesh member 160 perpendicularly intersects the longitudinal axis direction of the washing vessel 1100, and the state of the present embodiment means an intermediate state between the states of Embodiments 1 and 3.

The mesh member holding portion 1202A has an approximately tubular side wall portion 12021 that is partially cut out and that covers the mesh member 160 from the lateral side, and an approximately semicircular sloping support portion 12022 that is provided on an inner surface of the side wall portion 12021 and that holds the mesh member 160 in a sloping position from the lower lateral side.

### Washing of Mesh Member 160

When the mesh member 160 is washed using this thin plate member washing apparatus, as is the case with Embodiment 1, a defined amount of tap water 1300 is contained and the thin plate member fixing member 1200A is housed in the washing vessel 1100, and in this state, the washing vessel 1100 is shaken in the axial direction of the washing vessel 1100 (moved up and down) and thus the thin plate member fixing member 1200A reciprocates within the washing vessel 1100. This causes the tap water 1300 to flow over the surface of the mesh member 160, and medicinal fluid residue and the like deposited on the mesh member 160 are removed.

### Effects

As described above, also when the mesh member 160 is washed using the thin plate member washing apparatus of the present embodiment, the same effects as those of Embodiment 1 above can be obtained.

### Embodiment 3

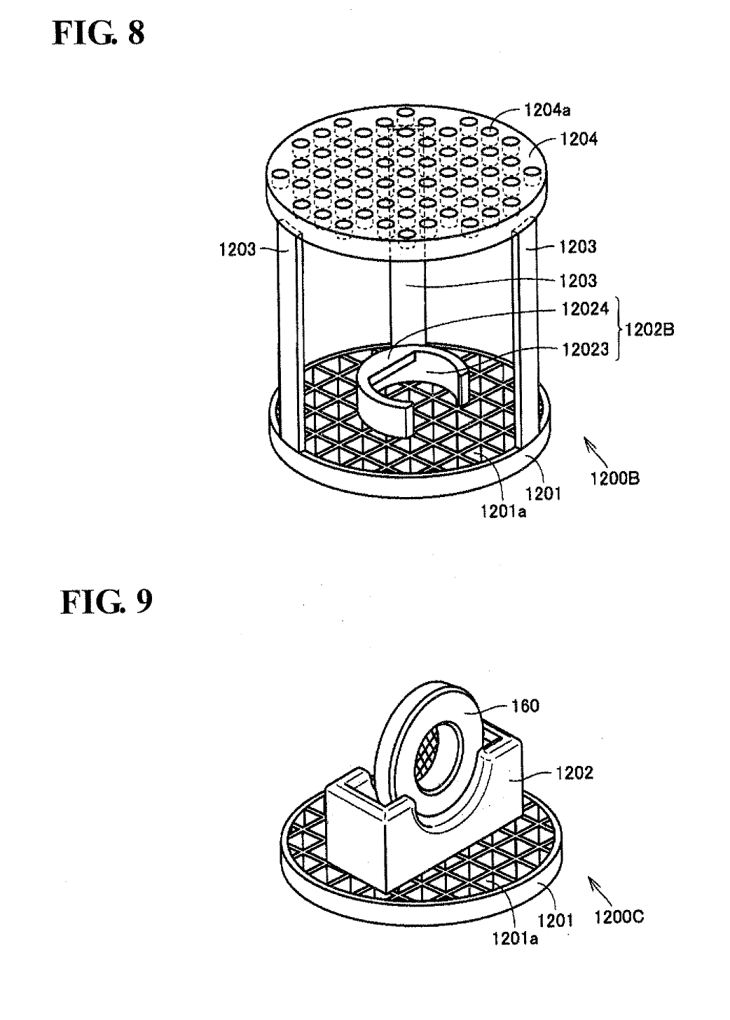

Next, the structure of a thin plate member washing apparatus of Embodiment 3 according to the present invention will be described with reference to FIG. 8. The thin plate member washing apparatus of Embodiment 3 has the same basic configuration as the above-described thin plate member washing apparatus 1000 of Embodiment 1. The difference is only the form of a mesh member holding portion 1202B of a thin plate member fixing member 1200B.

For this reason, in the drawings, the same components are denoted by the same reference numerals and duplication is eliminated, and only the mesh member holding portion 1202B of the thin plate member fixing member 1200B of the present embodiment will be described. FIG. 8 is a perspective view showing a specific configuration of the thin plate member fixing member 1200B.

### Thin Plate Member Fixing Member 1200B/Mesh Member Holding Portion 1202B

As shown in FIG. 8, the thin plate member fixing member 1200B of this embodiment is provided with the mesh member holding portion 1202B for holding the mesh member 160 in a state in which it is in a horizontal position on the upper surface side of the first base member 1201. Holding the mesh member 160 in the state in which it is in a horizontal position refers to a case where the plane containing the mesh member 160 perpendicularly intersects the longitudinal axis direction of the washing vessel 1100.

The mesh member holding portion 1202B has a partially discontinuous ring portion 12023 that holds the mesh member 160 from the lateral side and a retaining portion 12024 that holds the mesh member 160 from the upper surface side.

### Washing of Mesh Member 160

When the mesh member 160 is washed using this thin plate member washing apparatus, as is the case with Embodiment 1, a defined amount of tap water 1300 is contained and the thin plate member fixing member 1200B is housed in the washing vessel 1100, and in this state, the washing vessel 1100 is shaken in the axial direction of the washing vessel 1100 (moved up and down) and thus the thin plate member fixing member 1200B reciprocates within the washing vessel 1100. This causes the tap water 1300 to flow over the surface of the mesh member 160, and medicinal fluid residue and the like deposited on the mesh member 160 are removed.

### Effects

As described above, also when the mesh member 160 is washed using the thin plate member washing apparatus of the present embodiment, the same effects as those of Embodiment 1 above can be obtained.

### Embodiment 4

Next, the structure of a thin plate member washing apparatus of Embodiment 4 according to the present invention will be described with reference to FIG. 9. The thin plate member washing apparatus of Embodiment 4 has the same basic configuration as the above-described thin plate member washing apparatus 1000 of Embodiment 1. The difference is that the second base member 1204 and the support columns 1203 are not provided.

Also with this configuration, when the mesh member 160 is washed, as is the case with Embodiment 1, a defined amount of tap water 1300 is contained and a thin plate member fixing member 1200C is housed in the washing vessel 1100, and in this state, the washing vessel 1100 is shaken in the axial direction of the washing vessel 1100 (moved up and down) and thus the thin plate member fixing member 1200C reciprocates within the washing vessel 1100. This causes the tap water 1300 to flow over the surface of the mesh member 160, and medicinal fluid residue and the like deposited on the mesh member 160 are removed. Note that this configuration is also applicable to the thin plate member washing apparatuses of Embodiments 2 and 3 above.

### Effects

As described above, also when the mesh member 160 is washed using the thin plate member washing apparatus of the present embodiment, the same effects as those of Embodiment 1 above can be obtained.

### Embodiment 5

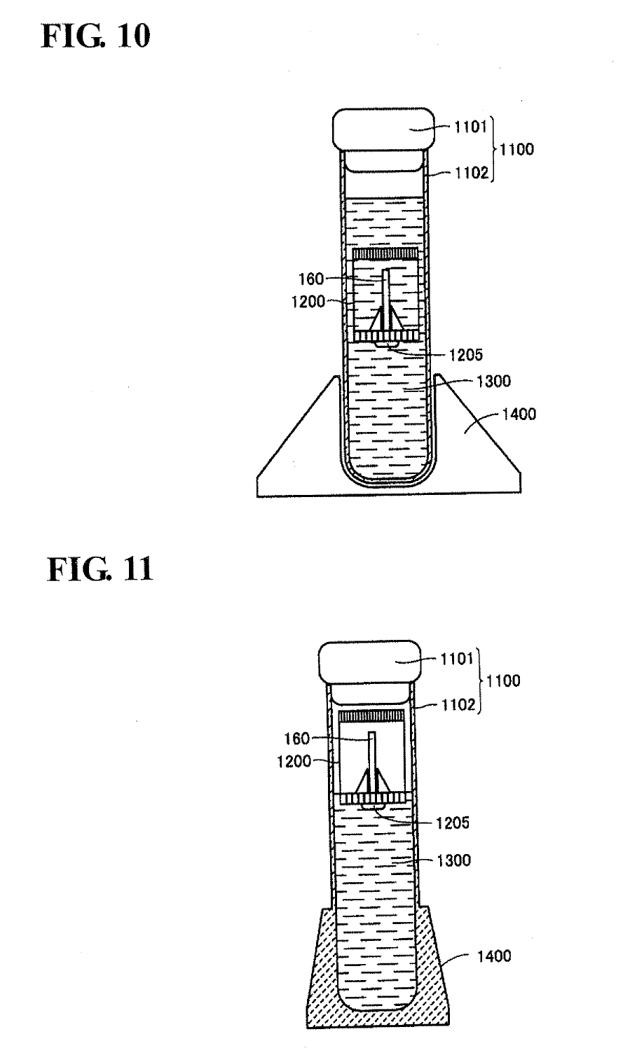

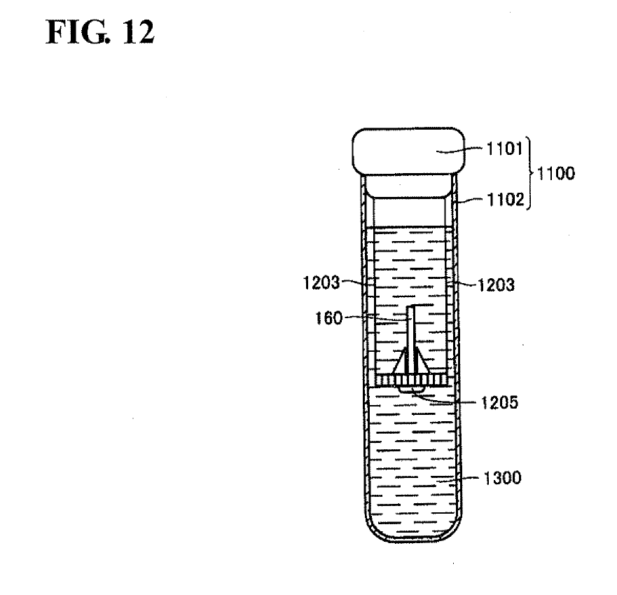

Next, the structure of a thin plate member washing apparatus of Embodiment 5 according to the present invention will be described with reference to FIG. 10. The thin plate member washing apparatus of Embodiment 5 is obtained by providing the thin plate member washing apparatus 1000 of Embodiment 1 with a stand 1400.

The thin plate member washing apparatus 1000 is left standing on the stand 1400 for a certain period of time after washing of the mesh member 160, and thus the medicinal fluid residue and the like settle on the bottom of the washing vessel 1100 and redeposition of the medicinal fluid residue and the like on the mesh member 160 can be prevented. Moreover, the opening area of the first openings 1201a provided in the first base member 1201 is set to a large value, and thus the medicinal fluid residue and the like can easily settle on the bottom of the washing vessel 1100.

The stand 1400 may be a separate component from the cylindrical vessel 1102, or may be integrally molded with the cylindrical vessel 1102. Furthermore, the shape of the stand 1400 is not limited to the shape shown in the drawing, and any form having a structure that can keep the washing vessel 1100 standing can be employed. This also applies to Embodiment 6, which will be described later.

### Embodiment 6

Next, the structure of a thin plate member washing apparatus of Embodiment 6 according to the present invention will be described with reference to FIG. 11. The thin plate member washing apparatus of Embodiment 6 has a configuration in which the thin plate member fixing member 1200 floats up to the liquid surface of the tap water 1300 so that the mesh member 160 is above the liquid surface within the cylindrical vessel 1102, in addition to the configuration described in Embodiment 5 above in which the thin plate member washing apparatus 1000 is provided with the stand 1400. To enable the thin plate member fixing member 1200 to float up, it is conceivable to use a material having a smaller specific gravity than the tap water 1300 for components of the thin plate member fixing member 1200 or to separately provide a buoyancy member so that the thin plate member fixing member 1200 as a whole has a smaller specific gravity than the tap water 1300. Note that the stand 1400 of the present embodiment is integrally molded with the cylindrical vessel 1102.

As described above, with the configuration in which the mesh member 160 floats up above the liquid surface of the tap water 1300, the mesh member 160 can be dried by leaving the thin plate member washing apparatus 1000 standing on the stand 1400 for a certain period of time after washing of the mesh member 160. Moreover, as is the case with Embodiment 5, the medicinal fluid residue and the like settle on the bottom of the washing vessel 1100, and redeposition of the medicinal fluid residue and the like on the mesh member 160 can be prevented.

### Embodiment 7

Next, the structure of a thin plate member washing apparatus of Embodiment 7 according to the present invention will be described with reference to FIG, 12. The thin plate member washing apparatus of Embodiment 7 has the same basic configuration as the above-described thin plate member washing apparatus 1000 of Embodiment 1. The difference is that the thin plate member fixing member 1200 is joined to the lid member 1101. Examples of such a structure include a structure in which the second base member is discarded and the support columns 1203 are joined to the lid member 1101.

With this structure, after washing of the mesh member 160, the mesh member 160 can be easily removed without the risk that the mesh member 160 may collide with the cylindrical vessel 1102, by detaching the lid member 1101 from the cylindrical vessel 1102.

Although the above embodiments have been described using the mesh member 160 for use in nebulizers as an example of the thin plate member to be washed, the thin plate member that can be used for the thin plate member washing apparatus according to the present invention is not limited to the mesh member for use in nebulizers, and the present invention is applicable to contact lenses and other thin plate members as well.

Although there have been described particular embodiments of the present invention, the embodiments disclosed herein are to be considered in all respects as illustrative and not restrictive. The scope of the present invention is defined by the appended claims, and all changes that fall within the meaning and scope equivalent to those of the claims are intended to be embraced therein.

### REFERENCE SIGNS LIST

100 nebulizer
110 nozzle
120 open/close operation portion
130 medicinal fluid storage portion
140 stepped horn
150 piezoelectric element
160 mesh member
161 thin plate member
162 resin member
180 fluid collecting portion
190 partition plate
200 mouthpiece
210 atomizer-side opening
211 flange portion
220 inhalation port
230 air intake
240 tubular portion
1000 thin plate member washing apparatus
1100 washing vessel
1101 lid member
1102 cylindrical vessel
1103 liquid surface line
1200, 1200A, 120013, 1200C thin plate member fixing member
1201 first base member
1201a first opening
1202, 1202A, 1202B mesh member holding portion
1202a groove portion
12021 side wall portion
12022 sloping support portion
12023 ring portion
12024 retaining portion
1203 support column
1204 second base member
1204a second opening
1300 tap water
1400 stand

1. A thin plate member washing apparatus comprising:
a washing vessel including a lid member and a cylindrical vessel having at one end an opening that is closed by the lid member and in which a liquid is contained; and
a thin plate member fixing member that is housed in the washing vessel and holds a thin plate member whose surface is washed with the liquid by moving within the washing vessel,
wherein the thin plate member fixing member has a first base member having a plurality of first openings that allow the liquid to pass through, and a thin plate member holding portion that is fixed to the first base member and holds the thin plate member, and
when the washing vessel is shaken in an axial direction of the washing vessel in a state in which the liquid is contained and the thin plate member fixing member is housed in the washing vessel, the thin plate member fixing member reciprocates within the washing vessel.

2. The thin plate member washing apparatus according to claim 1,
wherein the thin plate member fixing member has a second base member having a plurality of second openings that allow the liquid to pass through, in a position opposing the first base member with the thin plate member holding portion interposed therebetween.

3. The thin plate member washing apparatus according to claim 2, wherein an opening area of the first openings provided in the first base member is larger than an opening area of the second openings provided in the second base member.

4. The thin plate member washing apparatus according to claim 1, wherein the thin plate member fixing member has a shock absorbing member that reduces the shock of a collision with an inner surface of the cylindrical vessel.
